(19) United States
(12) Patent Application Publication
(10) Pub. No.: US 2008/0026855 A1
(43) Pub. Date: Jan. 31, 2008

(54) System and Method for Maintaining Relative Axial Positioning Between Two Rotating Assemblies

(75) Inventors: Mark T. Holtzapple, College Station, TX (US); George A. Rabroker, College Station, TX (US)

Correspondence Address: BAKER BOTTS L.L.P., 2001 ROSS AVENUE, SUITE 600, DALLAS, TX, 75201-2980, US

(73) Assignees: The Texas A&M University System, College Station, TX (US); StarRotor Corporation, College Station, TX (US)

(21) Appl. No.: 11/828,905

(22) Filed: Jul. 26, 2007

Related U.S. Application Data
(60) Provisional application No. 60/820,514, filed on Jul. 27, 2006.

(51) Int. Cl. F16C 3/00

(52) U.S. Cl. 464/7; 464/182

(57) ABSTRACT

According to one embodiment of the invention, a system for maintaining relative axial positioning between two rotating assemblies comprises a first rotatable assembly and a second rotatable assembly. The first rotatable assembly has captor plates. The captor plates form a cavity between a first of the captors plates and a second of the captor plates. The second rotatable assembly has a thrust plate. The thrust plate comprises a disc positioned within the cavity of the captor plates. The first rotatable assembly is axially positioned with respect to the second rotatable assembly through a rolling interaction between the thrust plate and the captor plates, or the second rotatable assembly is axially positioned with respect to the first rotatable assembly through a rolling interaction between the thrust plate and the captor plates.

### CROSS-REFERENCE TO RELATED APPLICATIONS

Pursuant to 35 U.S.C. § 119 (e), this application claims priority from U.S. Provisional Patent Application Ser. No. 60/820,514, entitled SYSTEM AND METHOD FOR MAINTAINING RELATIVE AXIAL POSITIONING BETWEEN TWO ROTATING ASSEMBLIES, filed Jul. 27, 2006.

### TECHNICAL FIELD OF THE INVENTION

This invention relates generally to the field of machinery having rotating assemblies and, more particularly, to a system and method of for maintaining relative axial positioning between two rotating assemblies.

### BACKGROUND OF THE INVENTION

There are currently several types of heat engines, each with their own characteristics and cycles. These heat engines include the Otto Cycle engine, the Diesel Cycle engine, the Rankine Cycle engine, the Stirling Cycle engine, the Erickson Cycle engine, the Carnot Cycle engine, and the Brayton Cycle engine. A brief description of each engine is provided below.

The Otto Cycle engine is an inexpensive, internal combustion, low-compression engine with a fairly low efficiency. This engine is widely used to power automobiles.

The Diesel Cycle engine is a moderately expensive, internal combustion, high-compression engine with a high efficiency that is widely used to power trucks and trains.

The Rankine Cycle engine is an external combustion engine that is generally used in electric power plants. Water is the most common working fluid.

The Erickson Cycle engine uses isothermal compression and expansion with constant-pressure heat transfer. It may be implemented as either an external or internal combustion cycle. In practice, a perfect Erickson cycle is difficult to achieve because isothermal expansion and compression are not readily attained in large, industrial equipment.

The Carnot Cycle engine uses isothermal compression and expansion and adiabatic compression and expansion. The Carnot Cycle may be implemented as either an external or internal combustion cycle. It features low power density, mechanical complexity, and difficult-to-achieve constant-temperature compressor and expander.

The Stirling Cycle engine uses isothermal compression and expansion with constant-volume heat transfer. It is almost always implemented as an external combustion cycle. It has a higher power density than the Carnot cycle, but it is difficult to perform the heat exchange, and it is difficult to achieve constant-temperature compression and expansion.

The Stirling, Erickson, and Carnot cycles are as efficient as nature allows because heat is delivered at a uniformly high temperature, Tₕₒₜ, during the isothermal expansion, and rejected at a uniformly low temperature, T_{cold}, during the isothermal compression. The maximum efficiency, ηₘₐₓ, of these three cycles is

ηₘₐₓ=1−T_{cold}/Tₕₒₜ

where the temperatures must be absolute.

This efficiency is attainable only if the engine is “reversible,” meaning that the engine is frictionless, and that there are no temperature or pressure gradients. In practice, real engines have “irreversibilities,” or losses, associated with friction and temperature/pressure gradients.

The Brayton Cycle engine is an internal combustion engine that is generally implemented with turbines and is generally used to power aircraft and some electric power plants. The Brayton cycle features very high power density, normally does not use a heat exchanger, and has a lower efficiency than the other cycles. When a regenerator is added to the Brayton cycle, however, the cycle efficiency increases. Traditionally, the Brayton cycle is implemented using axial-flow, multi-stage compressors and expanders. These devices are generally suitable for aviation in which aircraft operate at fairly constant speeds; they are generally not suitable for most transportation applications, such as automobiles, buses, trucks, and trains, which must operate over widely varying speeds.

The Otto cycle, the Diesel cycle, the Brayton cycle, and the Rankine cycle all have efficiencies less than the maximum because they do not use isothermal compression and expansion steps. Further, the Otto and Diesel cycle engines lose efficiency because they do not completely expand high-pressure gases, and simply throttle the waste gases to the atmosphere.

### SUMMARY OF THE INVENTION

According to one embodiment of the invention, a system for maintaining relative axial positioning between two rotating assemblies comprises a first rotatable assembly and a second rotatable assembly. The first rotatable assembly has captor plates. The captor plates form a cavity between a first of the captors plates and a second of the captor plates. The second rotatable assembly has a thrust plate. The thrust plate comprises a disc positioned within the cavity of the captor plates. The first rotatable assembly is axially positioned with respect to the second rotatable assembly through a rolling interaction between the thrust plate and the captor plates, or the second rotatable assembly is axially positioned with respect to the first rotatable assembly through a rolling interaction between the thrust plate and the captor plates.

According to one embodiment, the first rotatable assembly contains an inner rotor set of a gerotor compressor or expander. Additionally, the second rotatable assembly contains an outer rotor set of a gerotor compressor or expander.

Certain embodiments of the invention may provide numerous technical advantages. For example, a technical advantage of one embodiment may include the capability to maintain relative axial positioning between two rotating assemblies. Other technical advantages of other embodiments may include the capability to allow one rotating assembly to be axially located via axial thrust bearings or other means while allowing the other rotating assembly to follow the located assembly through excursions related to thermal expansion, vibration, or tolerance stack up. Yet other technical advantages of other embodiments may include the capability to integrate centrifugal pressure over the areas of a captor plate, resulting in a restoring force to preventing contact between the captor plate and a thrust plate.

Although specific advantages have been enumerated above, various embodiments may include all, some, or none of the enumerated advantages. Additionally, other technical advantages may become readily apparent to one of ordinary skill in the art after review of the following figures and description.

### BRIEF DESCRIPTION OF THE DRAWINGS

For a more complete understanding of example embodiments of the present invention and its advantages, reference is now made to the following description, taken in conjunction with the accompanying drawings, in which:

FIG. 1 shows a cross-section of a system 100, according to an embodiment of the invention; and

FIG. 2 shows a thrust plate/captor plate configuration, according to an embodiment of the invention;

FIG. 3 shows a thrust plate/captor plate configuration, according to another embodiment of the invention.

### DETAILED DESCRIPTION OF EXAMPLE EMBODIMENTS OF THE INVENTION

It should be understood at the outset that although example embodiments of the present invention are illustrated below, the present invention may be implemented using any number of techniques, whether currently known or in existence. The present invention should in no way be limited to the example embodiments, drawings, and techniques illustrated below, including the embodiments and implementation illustrated and described herein. Additionally, the drawings are not necessarily drawn to scale.

Bearings are utilized for axial and radial positioning of rotating assemblies within a system. However, difficulties arise when such systems become large because few, if any, satisfactory axial bearings exist for large rotating assemblies. Additionally, difficulties arise when multiple axial bearings are positioned on opposite ends of such systems because such axial bearings may act against one another with thermal expansion of components within the system. Further exacerbations of such difficulties arise due to requirements for tight tolerances in both axial and radial directions to maintain desired efficiencies.

Accordingly, teachings of some embodiments of the invention recognize a thrust plate/captor plate configuration that maintains relative axial positioning between two rotating assemblies. According to teachings of some embodiments, a thrust plate/captor plate configuration allows for one of the rotating assemblies to be axially located via, for example, axial thrust bearings or other similar configurations while allowing the other rotating assembly to follow the located assembly through excursions related to thermal expansion, vibration, or tolerance stack up. Further details are described below.

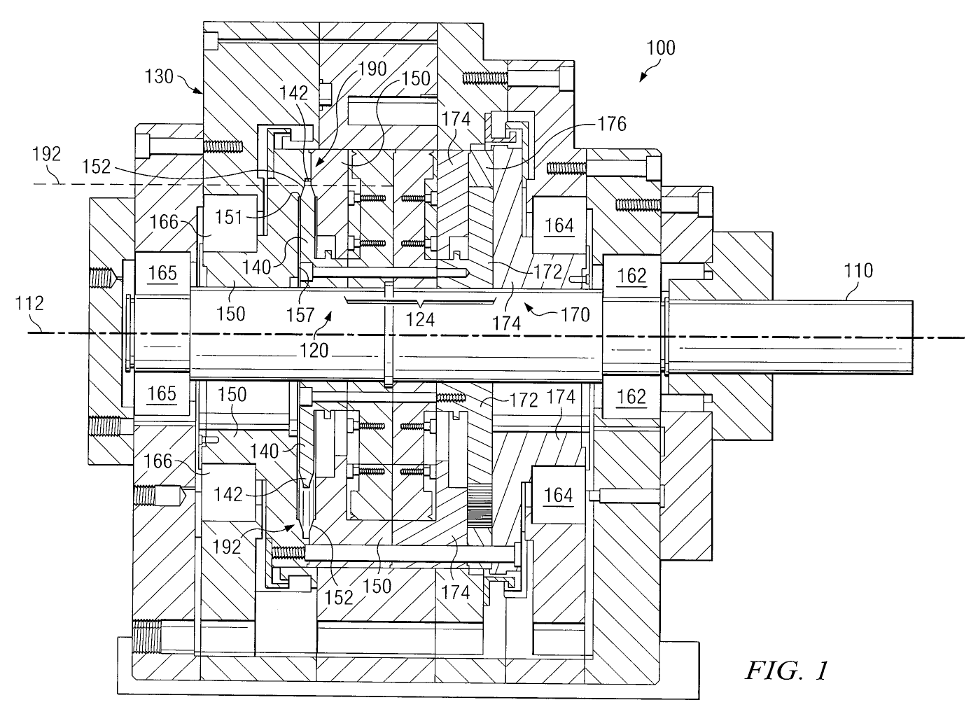

FIG. 1 shows a cross-section of a system 100, according to an embodiment of the invention. The embodiments of the thrust plate/captor plate configurations described herein may be used with a variety of different systems, including, but not limited to gerotor compressors and expanders. For purposes of illustration, the system 100 of FIG. 1 will be described with reference to components of a compressor system manufactured by Starrotor Corporation of College Station, Tex. In other embodiments, the thrust plate/captor plate configuration may used in conjunction with or applied to other machinery and/or systems. Such other machinery and/or systems include, but are not limited to the systems described in U.S. patent application Ser. Nos. 10/359,487; 10/359,488; 11/041,011; and 11/256,364; all of which are herein incorporated by reference.

The system 100 in the embodiment of FIG. 1 includes a shaft 110, an inner assembly 120, an outer assembly 130, a thrust plate 140, captor plates 150, and a gear assembly 170 with an inner gear 172 and an outer gear 176. In this embodiment, the system 100 includes a variety of bearings including axial and radial locating bearing 165 and radial locating bearings 162, 164, and 166. The only bearing used for axial positioning in this embodiment is the axial and locating bearing 165, which is used to axially position the inner assembly 120. Further axial positioning, for example, of the outer assembly 130, is accomplished using a thrust plate 140/captor plate 150 configuration described in greater detail below.

The inner assembly 120 in this embodiment is mounted to the shaft 110 and axially located with an axial and radial locating bearing 165. The inner assembly may include a variety of different positioned components 124, the details of which will vary depending on the particular system. The inner assembly 120 may also include an inner gear 172, which may be part of the inner assembly 120 or separate from the inner assembly 120, but coupled thereto. Further details of the inner gear 172 are described in greater detail below.

The thrust plate 140 in this embodiment is rigidly coupled to and rotates with the inner assembly 120. In particular embodiments, the thrust plate 140 may be considered part of the inner assembly 120. In other embodiments, the thrust plate 140 may be separate from the inner assembly 120. In this embodiment, the inner assembly 120, the thrust plate 140, the shaft 110, and the inner gear 172 all rotate about a shaft axis 112.

The captor plates 150 are rigidly coupled to and rotate with the outer assembly 130. In particular embodiments, the captor plates 150 may be considered part of the outer assembly 130. In other embodiments, the captor plates 150 may be separate from the outer assembly 130. In particular embodiments, the outer assembly 150 may includes an outer gear 176, which may be part of the outer assembly 130 or separate from the outer assembly 130, but coupled thereto. In this embodiment, the captor plates 150, the outer assembly 130, and the outer gear 172 all rotate about an outer assembly axis, which is parallel to the shaft axis 112.

The outer assembly 130 in this embodiment is axially located through the interaction of the thrust plate 140 and captor plates 150. Such an arrangement allows the outer assembly 130 to float with the inner assembly 120, which as described above is axially located with the axial and radial locating bearing 165. In other words, the thrust plate 140/captor plate 150 configuration allows both the inner assembly 120 and the outer assembly 130 to have the same axial reference datum and move together in the axial direction with thermal expansion of the system 100—the outer assembly 130 floating with respect to the inner assembly 120.

The thrust plate 140 in this embodiment is shown sandwiched between the captor plates 150, for example in a cavity 157 formed between the captor plates 150. In particular embodiments, the thrust plate 140 may be a disc with a beveled edge towards a tip 142 of the thrust plate 140. In particular embodiments, the captor plates 150 may have a corresponding receiving portion 152 to receive the tip 142 of the thrust plate 140. The thrust plate 140 and the captor plates 150 are shown as having a point of contact (e.g., via a lubricating fluid) at the tip 142 of the thrust plate 140, for example, at the location indicated by an arrow 190. This point of contact occurs at a pitch line 192.

In particular embodiments, the thrust plate 140 and captor plate 150 only contact one another at or near the pitch line 192. When the thrust plate 140 and the captor plate 150 are at or near the pitch line 192, they have relatively the same velocity. Accordingly, little if any slipping or friction occurs at this point of contact. Moving radially inward from this point of contact at the location of arrow 190 towards the shaft 110, the relative velocity between the thrust plate 140 and the captor plates 150 increase because the outer assembly 130 has a different axis of rotation than the inner assembly 120. Thus, FIG. 1 shows a step 151 in the contact plates 150 adjacent the receiving portion 152. The step 151 minimizes contact away from the pitch line 192 in other areas of the cavity 157 formed by the captor plates. In other words, in particular embodiments, the contact region between the thrust plate 140 and the captor plates 150 is a small area adjacent the pitch line 192.

As briefly referenced above, the outer assembly 130 has a different axis of rotation from the inner assembly 120. Accordingly, contact between the captor plates 150 and the thrust plates 140 does not occur at all locations of the tip 142 of the thrust plate 140. For example, at the point in time of the location of the components of the cross section of the system 100 of FIG. 1, the tip 142 of the thrust plate 140 is not in contact with the receiving portions 152 of the captor plates 150 at an area indicated by an arrow 192.

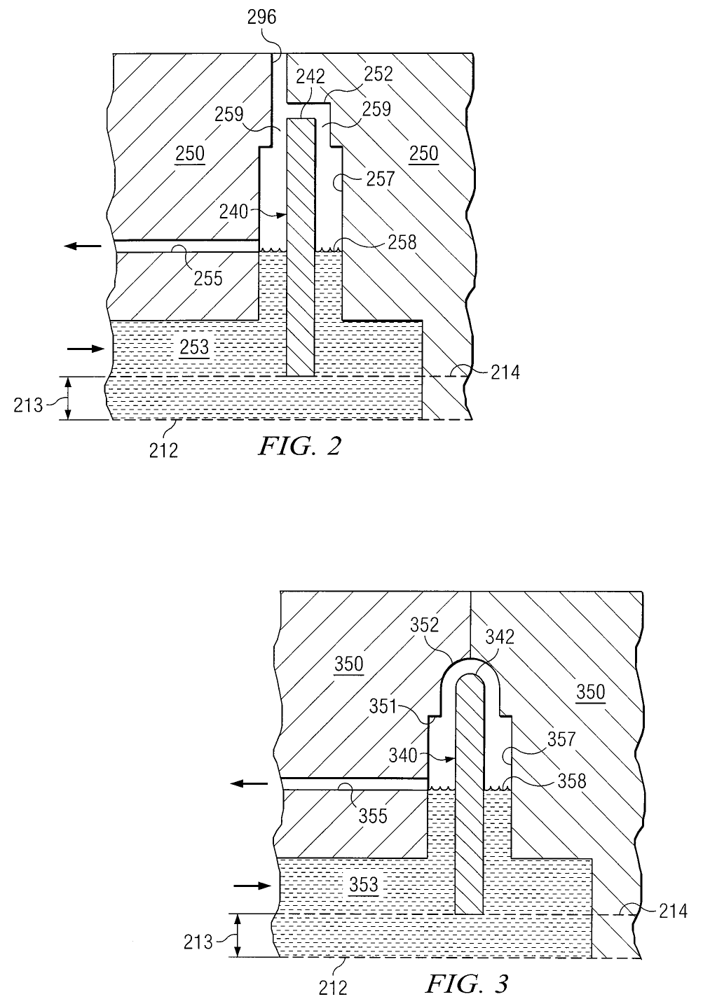

In particular embodiments, lubricating fluid may be injected into the cavity 157 and allowed to accumulate under centrifugal force to a radial level determined by drain holes. The lubricating fluid may include a variety of types of fluid, including, but not limited to lubricating oil. Further details of such a configuration are described with reference to FIGS. 2 and 3 below. With such a lubrication fluid, it should be understood that the general descriptions of “contacting” between the tip 142 of the thrust plate 140 and the receiving portion 152 of the captor plates 150 includes a contact which occurs via a thin lubricating fluid, which may exist therebetween.

In this embodiment, the gear assembly 170 includes an inner gear 172 mounted to the inner assembly 120 and an outer gear 176 mounted to the outer assembly 130. The rotation of the shaft 110, the inner assembly 120 and the inner gear 172 may force rotation of the outer assembly 130 or vice versa. The teeth of the inner gear 172 and the teeth of the outer gear 176 contact at the pitch line 192. In other words, in this embodiment, the pitch line 192 is the effect diameter of the inner gear 172.

In particular embodiments, the inner gear 172, itself, may serve as the thrust plate sandwiched between two metal plates 174, which serve as the captor plates. In such an embodiment, the metal plates 174 and the inner gear may be modified to facilitate such a function, for example, in the manners described herein with reference to the thrust plate/captor plate configuration. As one example intended for illustrative purposes only, the inner gear 17 may have a beveled tip with teeth at the very end (to mesh with the outer gear 176) and the metal plates 1 may have a receiving portion, which receives the beveled tips. As another example intended for illustrative purposes only, a cavity may be formed by the metal plates 174 and a lubricating fluid may be injected therein.

In this gear-used-as-thrust plate/captor-plate embodiment, two main points of contact may occur: (1) between the teeth of the inner gear 172 and the outer gear 176, and (2) the edges of the inner gear 172 being pinched between the metal plates 174. In this embodiment, the inner gear 172/metal plate 174 combination (serving as the thrust plate/captor plate combination) may be used solely for the additional axial alignment, not requiring an additional captor plate/thrust plate combination.

FIG. 2 shows a thrust plate 240/captor plate 250 configuration, according to an embodiment of the invention. The thrust plate 240/captor plate 250 configuration of FIG. 2 may operate in a similar manner to the thrust plate 140/captor plate 150 configuration of FIG. 1. However, a tip 242 of the thrust plate 240 is flat and a receiving portion 252 of the captor plates 250 captures the flat portion of the tip 242.

In the thrust plate 240/captor plate 250 configuration, excess lubricating fluid may be injected through a passage 253 into a cavity 257. Then, a constant head (e.g., at a fluid level 258) may be maintained by a level control fluid drain 255. Lubricating fluid may also leak radially outward through gaps 259 between the thrust plate 240 and the captor plates 250 and through passage 296. If a displacement of the captor plates 250 with respect to the axially fixed thrust plate 240 occurs, the gaps 259 may become imbalanced and the fluid column on the side with the larger gap 259 passes easily relieving centrifugal pressure while the centrifugal pressure on the side with the smaller gap 259 is maintained. The integration of the differential centrifugal pressure over the areas of the captor plates 250 may results in a restoring force which always forces the gaps 259 to be equal. In this embodiment, no physical contact is experienced between the thrust plate 240 and the captor plates 250.

FIG. 3 shows a thrust plate 340/captor plate 350 configuration, according to another embodiment of the invention. The thrust plate 340/captor plate 350 configuration of FIG. 3 may operate in a similar manner to the thrust plate 240/captor plate 250 configuration of FIG. 2, including among other items, a passage 353, a level control fluid drain 355, a cavity 357, and a fluid level 358. However, a tip 342 of the thrust plate 340 is rounded and a receiving portion 352 of the captor plates 350 captures the rounded tip 342. Additionally, in the embodiment of FIG. 3, no passage exists for escape of a lubricating fluid and the thrust plate 340 and the captor plates 350 contact one another. To minimize this contact between the thrust plate 340 and the captor plates 350, a step 351 may be used in the manner described with reference to the step 151 of FIG. 1.

With reference to FIGS. 2 and 3, an outer assembly axis 214 and a shaft axis 212 are shown. The distance between the two is a shaft offset 213. As referenced above, the inner assembly generally rotates about the shaft axis 214 and the other assembly generally rotates about the outer assembly axis 212.

As described above, the embodiments described herein may be used in conjunction with machinery and/or systems including, but not limited to the systems described in U.S. patent application Ser. Nos. 10/359,487; 10/359,488; 11/041,011; and 11/256,364.

Although the present invention has been described with several embodiments, a myriad of changes, variations, alterations, transformations, and modifications may be suggested to one skilled in the art, and it is intended that the present invention encompass such changes, variations, alterations, transformation, and modifications.

What is claimed is:

1. A system for maintaining relative axial positioning between two rotating assemblies, the system comprising:
a first rotatable assembly having captor plates, the captor plates forming a cavity between a first of the captors plates and a second of the captor plates, at least one of the captor plates including a first passage for allowing a lubricating fluid to be injected into the cavity;
a second rotatable assembly having a thrust plate; the thrust plate comprising a disc positioned within the cavity of the captor plates;
wherein the first rotatable assembly rotates about a first axis and the second rotatable assembly rotates about a second axis, the first axis parallel to the second axis;
wherein the first rotatable assembly is axially positioned with respect to the second rotatable assembly through a rolling interaction between the thrust plate and the captor plates, or the second rotatable assembly is axially positioned with respect to the first rotatable assembly through a rolling interaction between the thrust plate and the captor plates; and
wherein the first rotatable assembly and the second rotatable assembly have the same axial reference datum and move together in the axial direction with thermal expansion of the system.

2. The system of claim 1, wherein the thrust plate is part of a gear assembly.

3. The system of claim 2, wherein the thrust plate is an inner gear.

4. The system of claim 1, wherein
the thrust plate includes a shaped edge at an outer radius of the thrust plate;
the captor plates includes a receiving portion operable to receive the shaped edge;
the thrust plate contacts the captor plates; and
contact between the thrust plate and the captor plates only occurs at the shaped edge of the thrust plate and the receiving portion of the captor plates.

5. The system of claim 4, wherein
the contact between the thrust plate and the captor plates occurs at a pitch line, and
at the pitch line, the relative velocity of the shaped edge of the thrust plate and the receiving portion of the captor plates is the same.

6. The system of claim 1, wherein
the first rotatable assembly contains an inner rotor set of a gerotor compressor or expander, and
the second rotatable assembly contains an outer rotor set of a gerotor compressor or expander.

7. A system for maintaining relative axial positioning between two rotating assemblies, the system comprising
a first rotatable assembly having captor plates, the captor plates forming a cavity between a first of the captors plates and a second of the captor plates;
a second rotatable assembly having a thrust plate; the thrust plate comprising a disc positioned within the cavity of the captor plates; and
wherein the first rotatable assembly is axially positioned with respect to the second rotatable assembly through a rolling interaction between the thrust plate and the captor plates, or the second rotatable assembly is axially positioned with respect to the first rotatable assembly through a rolling interaction between the thrust plate and the captor plates.

8. The system of claim 7, further comprising:
an axial bearing that axially positions the second rotatable assembly, wherein the first rotatable assembly is axially positioned with respect to the second rotatable assembly.

9. The system of claim 7, wherein the first rotatable assembly and the second rotatable assembly have the same axial reference datum and move together in the axial direction with thermal expansion of the system.

10. The system of claim 7, wherein at least one of the captor plates includes a first passage for allowing a lubricating fluid to be injected into the cavity.

11. The system of claim 10, wherein the thrust plate is part of a gear assembly.

12. The system of claim 11, wherein the thrust plate is an inner gear.

13. The system of claim 10, wherein the thrust plate is not part of a gear assembly.

14. The system of claim 10, further comprising:
a first gap between an edge of the thrust plate and the first of the captors plates, and
a second gap between the edge of the thrust plate and the second of the captor plates, and a
a second passage in the captor plates disposed radially outward from the thrust plate, wherein
at least some of the lubricating fluid travels through the first and second gaps and out of the cavity through the second passage, and
the rolling interaction between the thrust plate and captor plates results in no contact between the thrust plate and the captor plates, pressures between the first and second gaps preventing such contact.

15. The system of claim 14, wherein differential centrifugal pressure over areas of the captor plates results in a restoring force which forces the first gap and the second gap to be equal.

16. The system of claim 10, wherein at least one of the captor plates includes a level control fluid drain operable to maintain a constant head of fluid within the cavity.

17. The system of claim 10, wherein the rolling interaction of the disc of the thrust plate in the cavity of the captor plates results in a contact between the thrust plate and the captor plates.

18. The system of claim 17, wherein
the thrust plate includes a shaped edge at an outer radius of the thrust plate, and
the captor plates includes a receiving portion operable to receive the shaped edge, and
contact between the thrust plate and the captor plates only occurs at the shaped edge of the thrust plate and the receiving portion of the captor plates.

19. The system of claim 18, wherein the contact between the thrust plate and the captor plates occurs at a pitch line.

20. The system of claim 18, wherein the shaped edge is beveled and the receiving portion is operable to receive the beveled edge.

21. The system of claim 18, wherein the shaped edge is rounded and the receiving portion is operable to receive the rounded edge.

22. The system of claim 18, wherein the captor plates comprise a step to minimize undesired contact between the thrust plate and the captor plates.

23. A system for maintaining relative axial positioning between two rotating assemblies, the system comprising:
captor plates, the captor plates operable to be coupled to a first rotating assembly, and the captor plates operable to form a cavity between a first of the captors plates and a second of the captor plates;
a thrust plate operable to be coupled to a second rotating assembly; the thrust plate comprising a disc operable to be positioned within the cavity of the captor plates; and
wherein a rolling interaction of the disc of the thrust plate in the cavity of the captor plates creates an axial positioning between the first rotating assembly and the second rotating assembly.

24. The system of claim 23, wherein at least one of the captor plates includes a first passage for allowing a lubricating fluid to be injected into the cavity.

25. The system of claim 24, wherein the thrust plate is part of a gear assembly.

26. The system of claim 25, wherein the thrust plate is an inner gear.

27. The system of claim 24, wherein the thrust plate is not part of a gear assembly.

28. The system of claim 24, wherein
the positioning of the thrust plate in the cavity allows a first gap between an edge of the thrust plate and the first of the captors plates and a second gap between the edge of the thrust plate and the second of the captor plates,
at least some of the lubricating fluid travels through the first and second gaps and out of the cavity through a second passage in the captor plates disposed radially outward from the thrust plate, and
the rolling interaction between the thrust plate and captor plates results in no contact between the thrust plate and the captor plates, the pressure between the first and second gaps preventing such contact.

29. The system of claim 28, wherein differential centrifugal pressure over areas of the captor plates results in a restoring force which forces the first gap and the second gap to be equal.

30. The system of claim 24, wherein at least one of the captor plates includes a level control fluid drain operable to maintain a constant head of fluid within the cavity.

31. The system of claim 23, wherein the rolling interaction of the disc of the thrust plate in the cavity of the captor plates results in a contact between the thrust plate and the captor plates.

32. The system of claim 31, wherein
the thrust plate includes shaped edges at an outer radius of the thrust plate, and
the captor plates includes a receiving portion operable to receive the shaped edge, and
contact between the thrust plate and the captor plates only occurs at the shaped edge of the thrust plate and the receiving portion of the captor plates.

33. The system of claim 32, wherein the contact between the thrust plate and the captor plates occurs at a pitch line.

34. The system of claim 32, wherein the shaped edge is beveled and the receiving portion is operable to receive the beveled edge.

35. The system of claim 32, wherein the shaped edge is rounded and the receiving portion is operable to receive the rounded edge.

36. The system of claim 32, wherein the captor plates comprise a step to minimize undesired contact between the thrust plate and the captor plates.
